(19) United States
(12) Patent Application Publication
(10) Pub. No.: US 2016/0247216 A1
(43) Pub. Date: Aug. 25, 2016

(54) SYSTEMS AND METHODS FOR GIFT MANAGEMENT

(71) Applicant: International Business Machines Corporation, Armonk, NY (US)

(72) Inventor: Sima Nadler, Kochav Yair (IL)

(21) Appl. No.: 14/628,303

(22) Filed: Feb. 23, 2015

(51) Int. Cl. G06Q 30/06; G06Q 50/00

(52) U.S. Cl. CPC G06Q 30/0633; G06Q 50/01

(57) ABSTRACT

There is provided a method for managing a list of given gifts, comprising: receiving, by a gift management module, gift information including a designated receiver of a gift; correlating the receiver with at least one contact entry in a contact list; mapping the at least one contact entry with the gift to generate at least one dataset entry of given gifts for each contact of the contact list, the dataset storing a list of given gifts; and adding the gift information to the list of given gifts of the at least one contact entry.

### BACKGROUND

The present invention, in some embodiments thereof, relates to systems and methods for gift management and, more specifically, but not exclusively, to systems and methods for management of gift giving and gift receiving.

Keeping track of gifts given and/or received may be performed manually. For example, after a wedding, the bridge and groom may open their gifts, manually making a list noting each gift giver and gift received. Manual record keeping is time consuming, prone to errors, and the paper records are easily lost.

### SUMMARY

According to an aspect of some embodiments of the present invention there is provided a method for managing a list of given gifts, comprising: receiving, by a gift management module, gift information including a designated receiver of a gift; correlating the receiver with at least one contact entry in a contact list; mapping the at least one contact entry with the gift to generate at least one dataset entry of given gifts for each contact of the contact list, the dataset storing a list of given gifts; and adding the gift information to the list of given gifts of the at least one contact entry.

Optionally, receiving comprises receiving a scan of a code coupled to the gift by a scanner in communication with the gift management module, the code encoding the gift information.

Optionally, the gift information further includes at least one member of the group consisting of: occasion, date, value of gift, description of gift; and further comprising linking the gift information with the at least one contact entry.

Optionally, the method further comprises associating a digital thank-you status with each of the given gifts of the dataset for each contact of the contact list, setting the digital thank-you status to represent NO, and changing the digital thank-you status for a certain given gift of the data for a certain user to represent YES in response to a command received from a user interface in communication with the gift management module.

Optionally, the gift information includes a description of the gift, and the method further comprises: searching the dataset based on the description to identify a sub-set of same or similar gifts; and presenting on a display, the contacts associated with the sub-set of same or similar gifts.

Optionally, the gift information includes a value of the gift, and the method further comprises: determining a relationship-type between the contact and a user of the gift management module; searching the dataset to identify other contacts having the relationship-type with the user; calculating a statistical value of given gifts for the other contacts; and presenting on a display, the value relative to the statistical value.

Optionally, the gift information includes a description of the gift, and the dataset for each contact of the contact list includes received gifts, and the method further comprises: searching the dataset based on the description to identify a sub-set of same or similar received gifts; and presenting on a display, an indication that same or similar gift has been received from the same receiver.

According to an aspect of some embodiments of the present invention there is provided a method for managing a received gift list, comprising: receiving, by a gift management module, gift information including a giver of a gift; correlating the giver with at least one contact entry in a contact list; mapping the at least one contact entry with the gift to generate a dataset of received gifts for each contact of the contact list, the dataset storing a list of received gifts; and adding the gift information to the list of received gifts of the at least one contact entry.

Optionally, the method further comprises: receiving, by a code generator module, from the giver of the gift, gift information including a designated receiver of the gift; printing, according to data generated by the code generator module, a code encoding the gift information; and wherein receiving comprises receiving a scan of the code coupled to the gift by a scanner in communication with the gift management module.

Optionally, the method further comprises: automatically activating a predefined communication application at a predefined time and/or date, to allow a user of the gift management module to thank the giver.

Optionally, the method further comprises: receiving a second gift information for a second gift received from the giver, the second gift being different than the existing received gift within the dataset of the mapped contact entry; replacing in the list of the dataset, the existing received gift with the second gift; and transmitting a message to the giver indicative of the replacing, the message containing instructions to update a dataset entry in communication with a gift management module of the giver indicative of the replacing.

Optionally, the method further comprises: automatically transmitting a message to a printer for printing, the message including an address of the at least one contact retrieved from the contact list.

According to an aspect of some embodiments of the present invention there is provided a system for managing at least one least of gift giving and gift receiving, comprising: a computing device comprising: a contact list storing a plurality of contact details of contact entries; a gift management module configured to: receive gift information including a gift contact related to a gift; and generate a dataset entry representative of the gift, the dataset mapped to at least one contact entry of the contact list, the dataset storing a list of received and given gifts, the at least one contact entry being correlated with the gift contact; and add gift information to the list of received and given gifts associated with at least one contact entry.

Optionally, the gift management module is further configured to calculate a statistical value of at least one of gifts given and gifts received for a selected sub-set of contact entries of the contact list.

Optionally, the computing device further includes a graphical user interface module configured to: receive at least one search parameter from a user, the search parameter including at least one member selected from the group consisting of: gift value, occasion, gift giver, gift receiver, gift type, and gift description; search the dataset according to the at least one search parameter; and display on a screen, a sub-set of contacts of the contact list mapped to dataset entries matching the at least one search parameter.

Optionally, the gift management module is further configured to receive the gift information from a scanner in communication with the computing device, the scanner configured to scan a code encoding the gift information on the gift. Optionally, the system further includes a code generator module for installation on an external computer, the code generator module configured to receive the gift information from a giver of the gift using an interface in communication with the external computer, and generate a message with instructions for printing the code encoding the gift information. Optionally, the code is a Quick Response (QR) code. Optionally, the code is printed on a sticker for attachment to the gift.

Optionally, the gift management module is further configured to: access a social network stored on a remote central server; share at least one contact entry including at least one dataset entry with another linked user of the social network; and search the shared data of linked users of the social network according to at least one search parameter.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system for management of a list of gifts given and/or received, in accordance with some embodiments of the present invention;

FIG. 2 is a block diagram of additional components of the system for management of a list of gifts given and/or received, in accordance with some embodiments of the present invention;

FIG. 3 is a flowchart of a method for managing a list of given gifts, in accordance with some embodiments of the present invention;

FIG. 4 is a flowchart of a method for managing a list of received gifts, in accordance with some embodiments of the present invention;

FIG. 5 is a flowchart of additional optional features for managing a list of given and/or received gifts, in accordance with some embodiments of the present invention;

FIG. 6 is a schematic of an exemplary architecture for implementation of the system for list management, in accordance with some embodiments of the present invention; and

FIG. 7 is a schematic of an exemplary architecture for sharing lists of gift information between users, in accordance with some embodiments of the present invention.

### DETAILED DESCRIPTION

The present invention, in some embodiments thereof, relates to systems and methods for gift management and, more specifically, but not exclusively, to systems and methods for management of gift giving and gift receiving.

An aspect of some embodiments of the present invention relates to a gift management module that maps gifts given and/or gifts received (by a user) to contacts of a contact-list application, and generates, for each contact, a list of gifts received by the user from the contact, and/or a list of gifts given by the user to the contact.

Optionally, different users manage different contact lists, each contact list associated with its own list of gift information. The different users may use their own locally installed gift management module, or a central gift management module. The different users may give and receive gifts between each other. The gift management module stores the lists in a customized relation to each user, by tracking for contacts of each user, the gifts given by the contact to the respective user, and/or the gifts received by the respective user from the contact. Each list stores the gift information from the viewpoint of the current user, instead of, for example, from the viewpoint of each contact and/or from a central viewpoint of all users. In this manner, the list may be processed (e.g., searched) from the viewpoint of each user. For example, when John (i.e., user A) gives a gift to Jack (i.e., user B), John's module stores, for the contact Jack, a list entry that a gift was given. Jack's module stores for the contact John, a list entry that a gift was received. Such list generation is different, for example, from a central system that stores a gift given for user A, and a gift received for user B.

Mapping may be performed using an interface (e.g., application programming interface (API)) of the contact-list, to match the given gifts and/or received gifts to the contact(s) that gave the gift and/or to the contact(s) that received the gift.

The gift data stored in relation to each contact of the contact list allows access to other existing information of the contact stored in association with the contact entry, for example, contact details for sending thank-you messages, and relationship status with the user for analyzing gift data (as described herein). The gift management module provides new electronic gift functionality features that do not have direct corresponding manual actions. The gift management module improves performance of a computing device executing the gift management module, by automatically generating contact links, entering gift data, and/or automatically accessing communication information of the gift related contact, instead of, for example, the user manually searching to obtain the information and/or entering redundant data into a stand-alone gift application, which is more time consuming and may require additional device resources.

Optionally, the gift list is automatically generated by the gift management module, separately for the giver and the receiver, upon receiving a scan of a code encoding the gift information. The code is generated according to information received directly from the giver of the gift (e.g., at the point of sale during purchase), such as the name of the designated gift receiver. In this manner, data is not required from the designated gift recipient for generation of the code. The code may be printed during purchase of the gift by the merchant at the store, or by the gift giver at home before the gift is given.

Optionally, the existing gift data is analyzed in real-time when a data of a new received and/or given gift is obtained, to provide feedback in relation to other existing gift data. Alternatively or additionally, the gift data is analyzed and/or searched prior to giving a new gift. The existing gift data may be analyzed to determine if the contact designated to receive the gift has already received the same or a similar gift. The existing gift data may be analyzed to determine if the value of the gift being given is statistically significantly different than the value of other gifts received, for example, the value is too high or too low relative to gifts received by other similar contracts. Optionally, the system provides functions to the giver of the gift, which may be different than the functions provided to the receiver of the gift. Optionally, the system provides the giver of the gift with the ability to keep track of thank-you's received from the gift receiver.

Optionally, each contact includes an associated relationship-type status representing the relationship with the current user, for example, an electronic tag, or a stored parameter. Examples of relationship-types include: close family member, distant family member, close friend, acquaintance, and co-worker. The gift analysis may be performed according to relationship-type, for example, the value of the gift being given to a co-worker is statistically compared to value of gifts given to and/or received from other co-workers.

Optionally, third party applications are automatically activated to contact the gift giver using contact information stored in the contact-list. The activation may occur during a predefined time and/or date. The automatic activation helps make sure that the user thanks the contact for giving the gift. For example, a wireless or internet protocol (IP) phone call to the phone number of the contact, an instant message to the instant message address of the contact, a social network message posted to the social network website of the contact, and an email to the email address of the contact.

Optionally, the contact-list application is a social network application (which may be an existing social network not originally designed for gift data, or a social network dedicated to gift data) that links the user with other users. The lists of gift data of the user may be shared with other linked users. The gift data lists of linked users may be analyzed together or separately from the gift data of the current user, for example, to determine whether the user is giving a gift that the contact has already received from somebody else, and to determine whether the value of the gift being given to the contact is statistically different than the value of gifts given by other (e.g., too high or too low). Alternatively or additionally, the contact-list application is a locally installed application, for example, a contact directory.

Before explaining at least one embodiment of the invention in detail, it is to to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

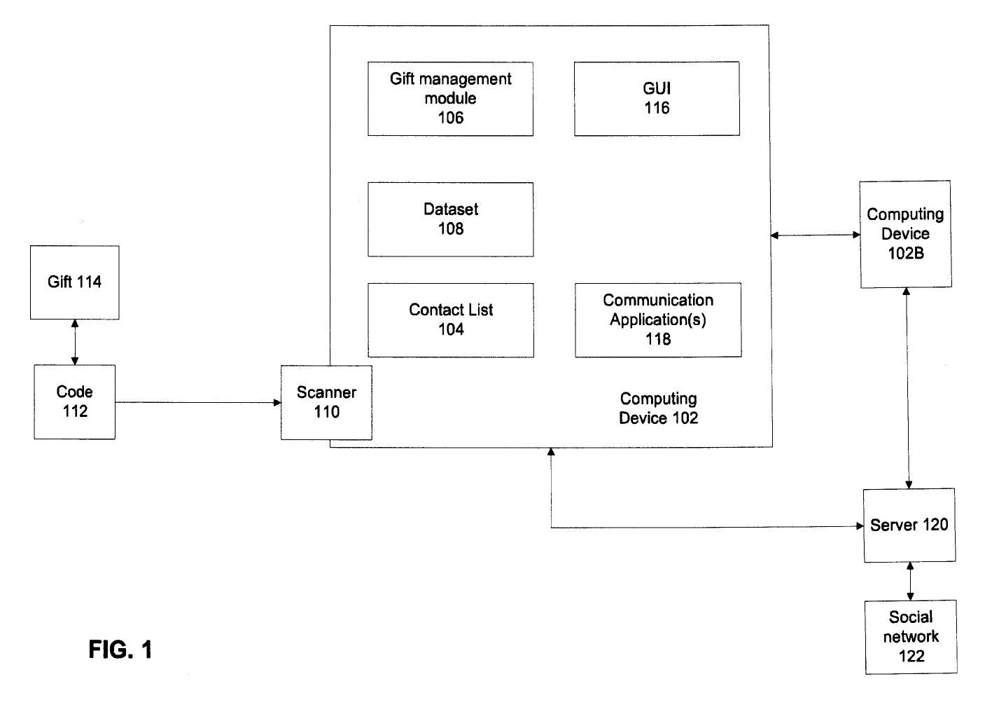

Reference is now made to FIG. 1, which is a block diagram of a system 100 for management of a list of gifts given and/or received, in accordance with some embodiments of the present invention. System 100 generates lists of given gifts and/or received gifts that are mapped to contact entries of a contact list of a user, allowing the user to keep track of the lists gifts received and/or gifts given, according to his/her contacts. System 100 allows for analysis of a gift according to previously received and/or given gift data stored in relation to the contact entries.

System 100 includes one or more computing devices 102, optionally mobile devices, for example a smartphone, a tablet, and a laptop computer. Each computing device 102 has stored thereon (or is in communication with) a contact list application 104 including multiple contact entries for contacts of the user, for example, a contact directory application, and a social network application. Contact list application 104 may be an application provided by an external third party. Application 104 may not necessarily be designed to store gift data as described herein, for example, application 104 may have been designed to store contact details and/or provide social networking.

Computing device 102 has stored thereon a gift management module 106 that receives gift information, including a gift contact related to a gift (i.e., the gift giver or gift receiver), and generates a dataset 108 entry representative of the gift information, optionally organized as one or more lists. Dataset 108 is mapped to one or more contacts in contact list 104 based on a correlation of the gift contact with the contact entry in contact list 104. It is noted that one gift may be given to multiple contacts, or multiple contacts may together give one gift to the user, in either case, the gift information is mapped to multiple contact entries. Each contact may have an associated sub-set of dataset 108 storing a history of gifts given to the contact and/or received from the contact.

Mapping may be performed through an interface (e.g., API) of contact list application 104, that allows linking of contact entries with the gift lists, as an externally stored list(s), and/or as an internal integrated list(s). Dataset 108 may be stored as an external module 108 mapped to application 104, or integrated within application 104, for example, as an add-on feature, or a plug-in application.

Optionally, computing device 102 includes (or is connected to) a scanner 110 that scans a code 112 attached to a gift 114 (which may be designated for giving, or has been received). Code 112 encodes the gift information, which is decoded by computing device 102. The gift information includes one or more of the following parameters: gift giver, gift receiver, occasion, date, value of gift, description of gift. The received gift information is linked with the correlated contact entry of application 104 through the gift giver or gift receiver (one of which is the contact entry, the other being the user).

Code 112 is, for example, a Quick Response (QR) code, a universal product code (UPC), a custom designed code, or another standardized code. Code 112 may be printed on a physical medium attachment to the gift, for example, a sticker, paper tapped to the gift, or plastic glued to a box containing the gift.

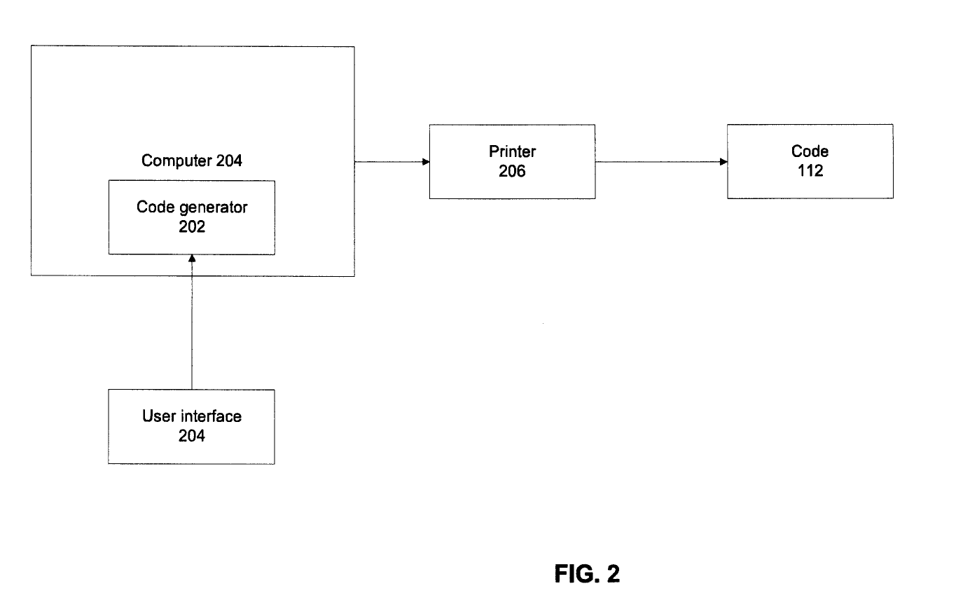

FIG. 2 is a block diagram of additional components of the system of FIG. 1 for gift management, in accordance with some embodiments of the present invention. Components 200 generate code 112, which is applied to gift 114 and decoded by computing device 102. Components 200 allow the code to be generated independently of the gift and/or to include additional gift details not available on existing codes of the gift (e.g., not in the UPC code), for example, after purchase at the store, or at home before the gift is given. Components 200 allow the system of FIG. 1 to be integrated with physically located stores selling gifts, instead of, or in additional to, online stores. The integration may be achieved without necessarily requiring communication with an external system, such as a central server. Components 200 provide the functionality of the system of FIG. 1, to virtually all gifts, without necessarily requiring entering data of the gifts into the system. Components 200 allow gift purchasers and/or gift receivers to use the system of FIG. 1, without necessarily requiring pre-registration, and/or account formation with the system (or a central server). The code generated by components 200 is scannable by both the gift giver and the gift receiver, which automatically generates the gift lists with the respective contact lists of the gift giver and the gift receiver.

A code generator module 202 is installed on an external computer 204, which may be a different computer than computing device 102. Code generator module 202 receives the gift information from a user interface 204, encodes the gift information, and generates a message with instructions for printing the code encoding the gift information. The message is transmitted to a printer 206, which prints code 112 on the physical medium (e.g., sticker) for application to the gift. The sticker containing the code may be applied, for example, at the store when the gift is purchased or at home after wrapping the gift. Printer 206 may be, for example, a receipt printer, printing code 112 on a gift receipt.

Optionally, code generator module 202 is designed for commercial retailers, for integration with a point of sale (POS) system, for example, with a cash register in a physical store. When a customer purchases a gift in the store, code generator 202 installed within the POS generates code 112. The gift information may be received from user interface 204, such as a loyalty card scanner or other customer identification. When such cards are not available, and/or additional gift information is entered (e.g., occasion, recipient), user interface 204 may include, for example, a screen and keyboard for manual entry. Some gift information may be automatically retrieved from a memory in communication with the POS, for example, the gift value and/or gift description.

Alternatively or additionally, code generator module 202 is designed for personal use, for example, used at home and/or by a small business. Computer 204 may be a desktop computer, a laptop, or other home computer. Code generator module 202 may be installed on computing device 102. At least some gift information may be manually entered using user interface 204 (e.g., touch screen, keyboard). At least some gift information may be automatically retrieved from other sources, for example, by scanning the UPC barcode of the gift, and/or by accessing the website of the gift manufacturer through a network connection. The message may be transmitted to the printed wirelessly using short range communication, wirelessly through a network, using a cable, or through a removable external memory card.

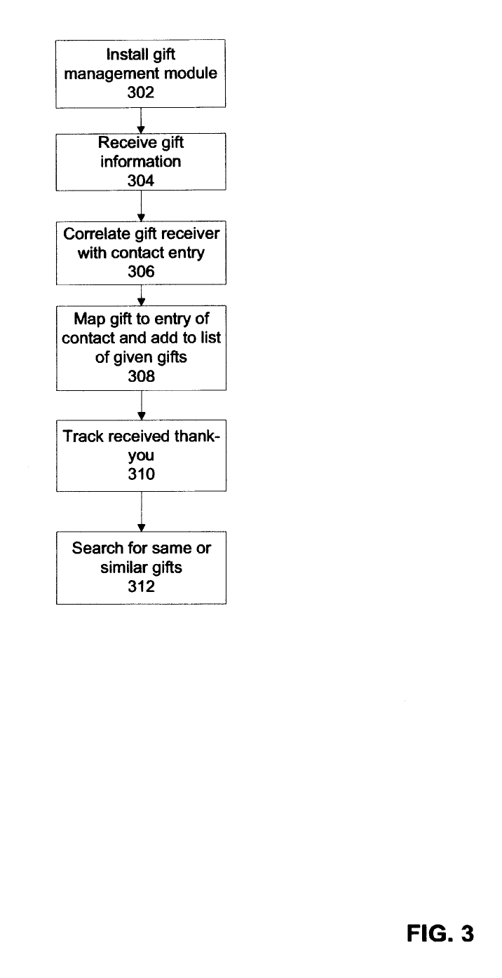

Reference is now made to FIG. 3, which is a flowchart of a method for managing lists of given gifts, in accordance with some embodiments of the present invention. The method allows a user to track which gifts were given to whom (optionally with additional details). The method provides analysis of the designated gift in relation to other received and/or given gifts. The method may be executing by system 100 of FIG. 1, and will be described in relation to components of system 100.

At 302, gift management module 106 is installed on computing device 102. Module 106 may be downloaded from a central server, or obtained from local physical memory (e.g., external card). Alternatively, gift management module 106 is located on a central server, accessed by computing device 102 using a network connection.

At 304, gift information is received by gift management module 106. The gift information includes at least the destined receiver of the gift. The gift information to may be received by scanner 110 scanning code 112 encoding the gift information. Code 112 is attached to gift 114, for example, in a card provided with the gift, on the box containing the gift, and/or on the wrapping paper around the gift.

The user scanning the code automatically triggers logging of the gift information encoded within the gift code. It is noted that the giver that is giving the gift scans the same code that is designed to also be scanned by the receiver of the gift. It is noted that different gift lists are generated for the gift giver and the gift receiver, as described herein.

Alternatively or additionally, the gift information (or part thereof) may be manually entered by the user using a user interface (e.g., touch screen, keyboard), and/or retrieved from another location (e.g., received as an electronic message from the gift sender).

At 306, the gift receiver is correlated with one or more contact entries in contact list application 104. The correlation may be based on a predefined similarity threshold, to match similar contacts, for example, different spellings, and/or nicknames. When multiple contacts are matched, the user may manually select one or more of the entries using a graphical user interface (GUI) 116 in communication with gift management module 106, for example, via a touch-screen connected to computing device 102.

At 308, the designated contact entry is mapped to the gift information. The gift information and/or mapping are stored within dataset 108. Optionally, dataset 108 stores the given gifts as a list. The gift information is added to the list of given gifts of the correlated contact entry.

The new gift information is added to dataset 108, which contains a history of given gifts, such as, for each gift, what was given to whom, when the gift was given, why the gift was given (e.g., occasion), and the value of the given gift.

Optionally, at 310, a digital thank-you status may be associated with each of the given gifts within dataset 108 for each contact of the contact list 104. The user may use GUI 116 to select whether or not a thank-you is received for the given gift.

A digital thank-you status related to each give may be set to a default value, for example, to represent NO. The digital thank-you status for the gift is changed (e.g., to represent YES) in response to a command received from GUI 116, for example, by the user when the gift receiver sends a thank you note or phone call.

In this manner, the user may keep track of which contacts that received gifts thanked the user for the gift.

Optionally, at 312, dataset 108 is searched to identify a sub-set of same or similar gifts. The identified same or similar gifts are displayed using GUI 116 on a screen connected to computing device 102, along with the contact associated with each identified gift and/or additional gift information. The search helps the gift giver determine whether the gift is appropriate in view of previously received and/or given gifts.

The searching may be automatically triggered upon receiving the gift information. Alternatively or additionally, the searching is manually triggered through GUI 106, for example, by the user performing the search before the gift has been purchased and/or given.

Optionally, the search is performed according to the relationship-type between the user and the gift receiver. Gift data of other contacts having the same or similar relationship-type is searched. In this manner, gifts given to people with similar relationships to the user are analyzed. For example, similar gifts may be given to people with similar relationships (e.g., to co-workers), but different gifts may be given to people with different relationships, such as giving different gifts to an acquaintance and to a close family member.

Alternatively or additionally, the search is performed according to gifts given by the user. Alternatively or additionally, the search is performed according to received gifts by the user.

Alternatively or additionally, the search is performed according to the value of the gift designated for giving. Optionally, a statistical value of gifts given to and/or received from other contacts is calculated, for example, the average (which may include a standard deviation and/or distribution) gift value. The value may be compared to the value of the designated gift to identify variations, for example, the gift value is too low compared to other gifts given to contacts with a similar relationship-type, or the gift value is too high compared to gifts received from other contacts.

Alternatively or additionally, the search is performed according to a description of the gift, to identify a sub-set of same or similar received gifts. Optionally, the search identifies that the same or similar gift has already been given to the same person, or to a close relationship-type of the person, for example, the same gift was given to the spouse of the current gift receiver, or the same gift was given 5 years ago to the same person for a different occasion. An indication message may be generated by GUI 116 and displayed on the screen. In this manner, the user may be spared embarrassing situations of giving the same gift twice, or giving the same gift to closely related people. It is noted that contact list 104 may contain relationship-types and/or links between contacts.

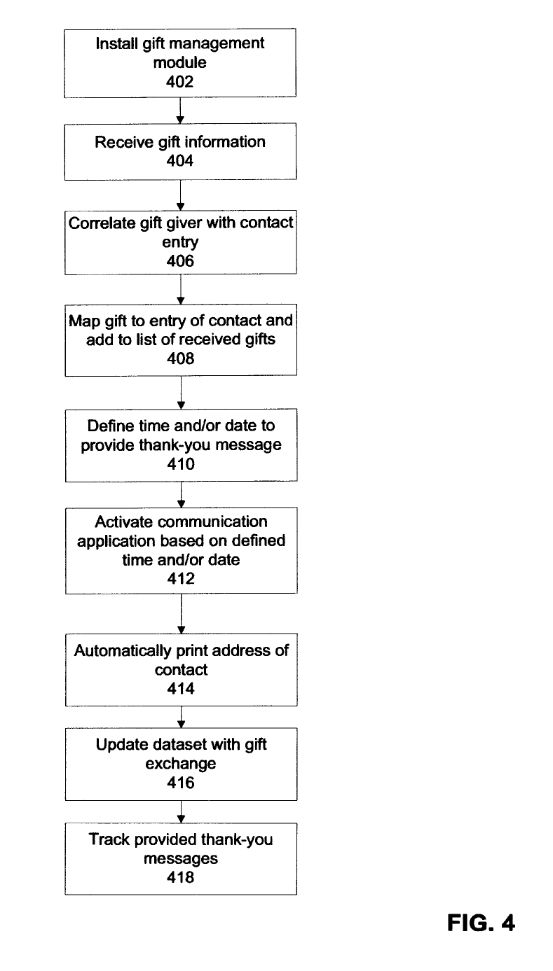

Reference is now made to FIG. 4, which is a flowchart of a method for managing lists of received gifts, in accordance with some embodiments of the present invention. The method allows a user to track which gifts were received from whom (optionally with additional details). The method may provide automatic activation of third part communication applications and/or automatic printing, to contact the gift giver using contact details in the contact list. The method may be executing by system 100 of FIG. 1, and will be described in relation to components of system 100.

At 402, gift management module 106 is installed on computing device 102, for example, as described with reference to block 302 of FIG. 3.

At 404, gift information of a received gift is received by gift management module 106, for example, as described with reference to block 304 of FIG. 3.

It is noted that gift management module 106 automatically triggers the relevant process for gift giving or gift receiving, based on the received gift information. For example, when the gift receiver is identified in contact list 104 but the gift giver is not identified, module 106 triggers the process for gift giving (e.g., method of FIG. 3), assuming that the unidentified giver is the user. Alternatively, the name of the user is stored in module 106.

At 406, the gift giver (identified from the gift information) is correlated with one or more contact entries in contact list application 104, for example, as described with reference to block 306 of FIG. 3.

At 408, the contact entry correlated with the gift giver is mapped to the gift information as an entry in dataset 108, for example, as described with reference to block 308 of FIG. 3. Optionally, dataset 108 stores the received gifts as a list. The gift information is added to the list of received gifts of the correlated contact entry.

Optionally, at 410, a time and/or date is defined for sending a thank-you message to the gift sender. The time and/or date may be a deadline by which to send the thank-you message, and/or the defined point for sending the message. Defaults may be pre-set, for example, in 1 hour, in 24 hours, in 1 week, or on the upcoming weekend. The user may select to cancel and/or activate the time and/or date for the message.

Alternatively, other conditions are defined for sending the thank-you, for example, during free time of the user retrieved from an electronic schedule of the user, the next time the user activates a certain communication application, or the next time the user communicates with the contact.

Optionally, at 412, a third party communication application 118 installed on or in communication with computing device 102 is automatically activated, for example, an instant message program, a voice phone call, an IP phone call, an email, a social network website, and a link to ecard services. The application 118 to activate may be predefined, for example, based on user preference, based on preference of the contact, and/or based on recent activity of the user and/or contact.

The automatic activation may occur at the predefined time and/or date. An indication may appear to the user (e.g. on the screen) reminding the user to thank the giver for the gift.

Application 118 may automatically initiate communication with the contact according to the available communication details stored in contact list 104, for example, call a phone number, open an email message with an email address, open an instant message window with the instant message address, or open a web-browser following the link of the personal social network site.

Thank-you templates (e.g., stored in communication with module 106), which are optionally customizable, may be automatically accessed and entered into the activated communication application 118, for example, a thank-you template for posting to the social network website of the gift giver, or a thank-you template for sending as an instant message.

Alternatively or additionally, at 414, a message is automatically generated and transmitted to a printer for printing addresses for mailing thank-you notes. The message, which may be transmitted over a network or wirelessly to the printer, includes the address of the contact retrieved from the contact list.

Optionally, at 416, dataset 108 is updated with details of a new gift when the previous gift is exchanged for the new gift. The dataset 108 may contain information of the old gift, and/or a representation that the new gift is an exchange of a previous gift.

The update may be automatically triggered when new gift information is received associated with the same giver. The new gift may be identified as an exchange when the new gift is different than the existing received gift, and/or optionally when the new gift is received within a predefined period of time short enough suggesting an exchange rather than a new gift for a new occasion, for example, within 1 day, 1 week, or 1 month. Alternatively, the gift information (e.g., encoded in the code) denotes that the new gift is an exchange.

Optionally, the gift giver is updated with the information that the user has exchanged the gift. A message may be transmitted to the giver (e.g., wirelessly over a network) indicative of the gift exchange. The message may contain instructions to automatically update the dataset entry in the computing device of the giver with the updated gift information. In this manner, the gift giver is informed of the exchange, and able to use the new information when performing his/her own gift analysis.

Optionally, at 418, gifts requiring thank-you messages are tracked. Optionally, GUI 116 allows the user to search dataset 108 for gifts for which thank-you messages have not been sent. Alternatively, periodically such as at predefined intervals (e.g., daily or weekly), remaining gifts requiring thank-you messages are identified. The list of remaining gifts may be displayed to the user on the screen, and/or communication applications may be automatically initiated, as described herein.

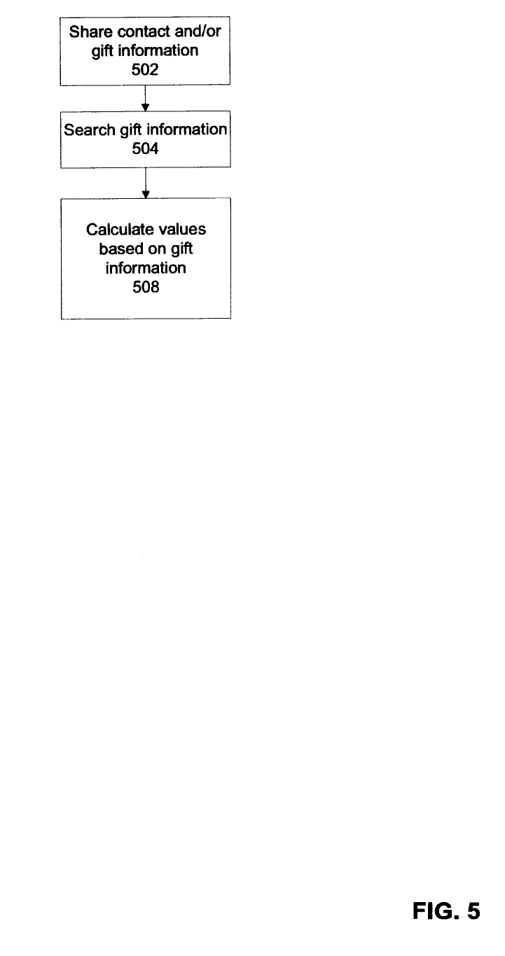

Reference is now made to FIG. 5, which is a flowchart of additional optional features for managing lists of given and/or received gifts, in accordance with some embodiments of the present invention. The additional features may be performed in real-time when the user has received a gift, when the user is giving a gift, prior to the purchase of a gift (e.g., to analyze the gift), and/or without an association with a gift (e.g., to analyze gift trends).

Optionally, at 502, one or more contact entries having mapped dataset 108 entries are shared and/or linked with another user, for example, when the other user doesn't have the same shared contacts. Alternatively or additionally, dataset 108 entries of one or more contact entries are shared and/or linked with another user who also has a contact entry for one or more of the same contact(s).

The sharing may be performed directly between computing device 102 and another computing device 102B (e.g., between two Smartphones), for example using a short-range wireless communication protocol, or through a wireless network. Alternatively, the sharing is performed via an external remote server 120. Server 120 may host a social network website 122, which allows linked users who share certain details to access each other's data, for example to perform searches. Social network 122 may be a pre-existing social network, which may be extended (e.g., using an API) to store gift data, or a social network 122 dedicated to sharing of gift data.

Server may host or connect to retail gift registries to retrieve information from gift registries. The information in the gift registry may be considered as shared within the social network, allowing users access to the data, for example, to determine whether a gift has already been received from another user. The server may connect with a gift recommendation system, which may analyze the data to help recommend a gift for a certain contact, for example, by analyzing the value of gifts given, gifts received, and types of gifts. For example, a collector of model cars may be identified based on having received different model cars, which may generate a recommendation for another model car as a gift, or a set of model paint, or a ticket to a model trade-show.

Optionally, the shared contact entry is incorporated into the contact list of computing device 102B. Alternatively or additionally, the shared contact entry and/or gift information are accessible to the user, for example, when performing searches.

Optionally, at 504, GUI module 116 allows the user to search gift information within gifts lists of dataset 108. The search may be performed according to one or more search parameters entered by the user: gift value, occasion, gift giver, gift receiver, gift type, and gift description. GUI 116 may display on the screen, the sub-set of contacts of the contact list 104 that are mapped to dataset 108 entries matching the search parameter(s).

The search may be performed to determine if the gift recipient (or a close relative) has already received a similar gift from another user, currently for the same occasion, or in the past for a different occasion.

Optionally, at 506, statistical values and/or value trends may be calculated for the given gifts and/or received gifts, by gift module 106. The user may define the sub-set of contact entries for which the values are calculated, and/or the calculations to perform using GUI 116. For example, calculate the average (optionally with standard deviation) value of gifts given and/or received for contacts of a certain relationship-type. For example, compare the average value of gifts given to the average value of gifts received per contact, such as to identify contacts in which gift giving and receiving is unbalanced (e.g., over a threshold).

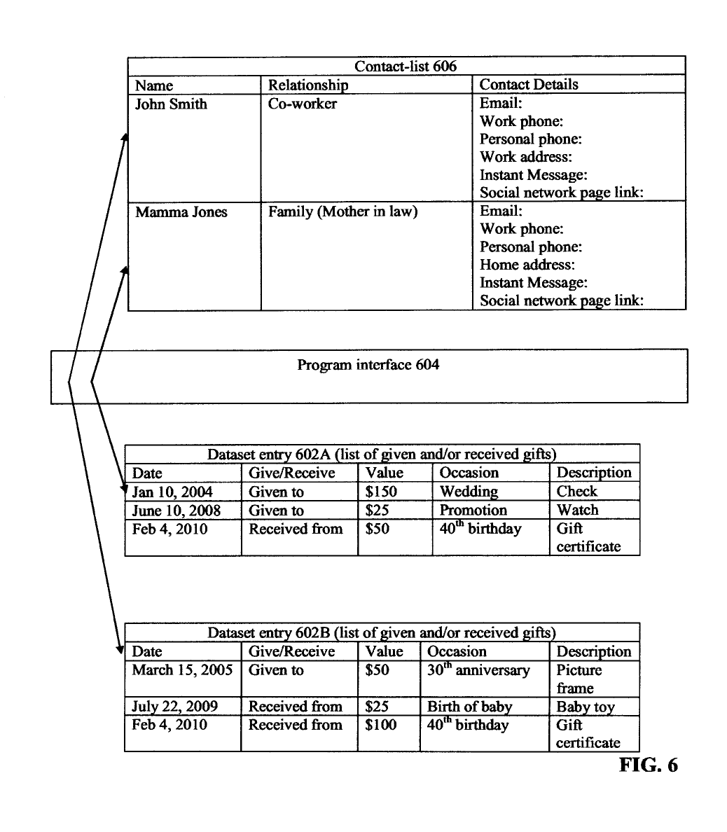

Reference is now made to FIG. 6, which is a schematic of an exemplary architecture for implementation of the system for list gift management, in accordance with some embodiments of the present invention. Dataset entries 602A-B are mapped to respective contact entries of a contact-list 606 by a program interface 604 (e.g., API). The dataset entries are mapped to pre-existing contact entries of a contact-list application which may have been designed for applications other than gift management, for example, to store contact details of contacts.

Dataset entries 602A-B optionally include lists of given gifts and/or lists of received gifts. Alternatively or additionally, each of dataset entry 602A-B may be, for example, a record, a table, an array, a matrix, an array of arrays, an object, or other data structures. Data stored within each entry 602A-B may correspond to gift management data of the respective contact as described herein, for example, gift received or gift given, date, value, occasion, and/or description of the gift.

Each entry 602A-B is mapped to a respective contact entry 606. Each contact entry stores contact details of the contact (e.g., email, phone number, address, instant message contact, and social network page link), the contact name, and optionally the relationship-type between the contact and the user. Mapping may be performed by program interface 604, for example, by links, data pointers, copying of data, and file storage. Dataset entries 602A-B may be stored as a separate module mapped to the contact list, or integrated within new data fields of the contact list.

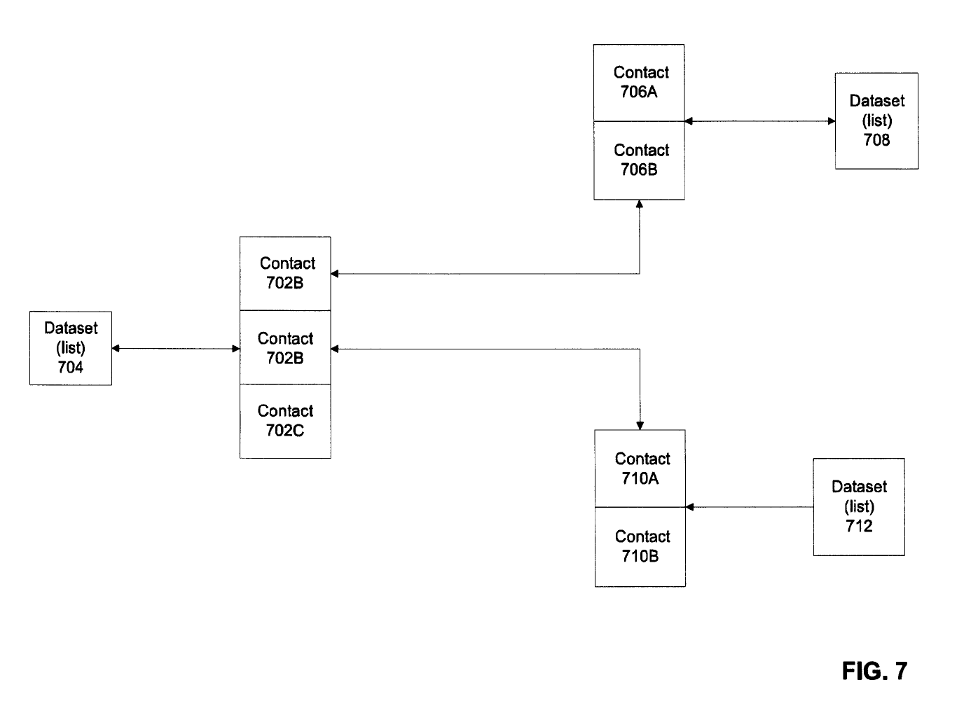

Reference is now made to FIG. 7, which is a schematic of an exemplary architecture for sharing gift information between users, in accordance with some embodiments of the present invention. Users may selectively decide which contact details to share, and who to share them with. Privacy may be maintained, by granting access to gift data to other selected users.

Contact entries 702A-C are mapped to dataset 704 storing lists of gift information, as described herein. A user shares contact entries 702A-C and corresponding mapped dataset 704 entries with contact 702B, and/or receives shared access to dataset 708 mapped to contact entries 706A-B. The user may share contact entries 702A-C and mapped dataset 704 with contact 702B, and/or receives shared access to dataset 712 mapped to contact entries 710A-B. The user may search and/or access gift data (e.g., to calculate values) within dataset 704, 708, and 712, as described herein.

Datasets 704, 708, and 712 may be stored on different computing devices. Access to the shared data may be performed by point to point communication between the computing devices, for example, by short range direct communication, or through the cellular network (e.g., when the computing devices are remotely located form one another). Alternatively or additionally, datasets 704, 708, and 712 may be stored on a central server. Access to the shared data may occur through a network connection between the computing devices and the server.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms computing device, code, and server are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some to embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for managing a list of given gifts, comprising:
receiving, by a gift management module, gift information including a designated receiver of a gift;
correlating the receiver with at least one contact entry in a contact list;
mapping the at least one contact entry with the gift to generate at least one dataset entry of given gifts for each contact of the contact list, the dataset storing a list of given gifts; and
adding the gift information to the list of given gifts of the at least one contact entry.

2. The method of claim 1, wherein receiving comprises receiving a scan of a code coupled to the gift by a scanner in communication with the gift management module, the code encoding the gift information.

3. The method of claim 1, wherein the gift information further includes at least one member of the group consisting of: occasion, date, value of gift, description of gift; and further comprising linking the gift information with the at least one contact entry.

4. The method of claim 1, further comprising associating a digital thank-you status with each of the given gifts of the dataset for each contact of the contact list, setting the digital thank-you status to represent NO, and changing the digital thank-you status for a certain given gift of the data for a certain user to represent YES in response to a command received from a user interface in communication with the gift management module.

5. The method of claim 1, wherein the gift information includes a description of the gift, and further comprising:
searching the dataset based on the description to identify a sub-set of same or similar gifts; and
presenting on a display, the contacts associated with the sub-set of same or similar gifts.

6. The method of claim 1, wherein the gift information includes a value of the gift, and further comprising:
determining a relationship-type between the contact and a user of the gift management module;
searching the dataset to identify other contacts having the relationship-type with the user;
calculating a statistical value of given gifts for the other contacts; and
presenting on a display, the value relative to the statistical value.

7. The method of claim 1, wherein the gift information includes a description of the gift, and the dataset for each contact of the contact list includes received gifts, and further comprising:
searching the dataset based on the description to identify a sub-set of same or similar received gifts; and
presenting on a display, an indication that same or similar gift has been received from the same receiver.

8. A method for managing a received gift list, comprising:
receiving, by a gift management module, gift information including a giver of a gift;
correlating the giver with at least one contact entry in a contact list;
mapping the at least one contact entry with the gift to generate a dataset of received gifts for each contact of the contact list, the dataset storing a list of received gifts; and
adding the gift information to the list of received gifts of the at least one contact entry.

9. The method of claim 8, further comprising:
receiving, by a code generator module, from the giver of the gift, gift information including a designated receiver of the gift;
printing, according to data generated by the code generator module, a code encoding the gift information; and
wherein receiving comprises receiving a scan of the code coupled to the gift by a scanner in communication with the gift management module.

10. The method of claim 8, further comprising:
automatically activating a predefined communication application at a predefined time and/or date, to allow a user of the gift management module to thank the giver.

11. The method of claim 8, further comprising:
receiving a second gift information for a second gift received from the giver, the second gift being different than the existing received gift within the dataset of the mapped contact entry;
replacing in the list of the dataset, the existing received gift with the second gift; and
transmitting a message to the giver indicative of the replacing, the message containing instructions to update a dataset entry in communication with a gift management module of the giver indicative of the replacing.

12. The method of claim 8, further comprising:
automatically transmitting a message to a printer for printing, the message including an address of the at least one contact retrieved from the contact list.

13. A system for managing at least one least of gift giving and gift receiving, comprising:
a computing device comprising:
a contact list storing a plurality of contact details of contact entries;
a gift management module configured to:
receive gift information including a gift contact related to a gift; and
generate a dataset entry representative of the gift, the dataset mapped to at least one contact entry of the contact list, the dataset storing a list of received and given gifts, the at least one contact entry being correlated with the gift contact; and
add gift information to the list of received and given gifts associated with at least one contact entry.

14. The system of claim 13, wherein the gift management module is further configured to calculate a statistical value of at least one of gifts given and gifts received for a selected sub-set of contact entries of the contact list.

15. The system of claim 13, wherein the computing device further includes a graphical user interface module configured to:
receive at least one search parameter from a user, the search parameter including at least one member selected from the group consisting of: gift value, occasion, gift giver, gift receiver, gift type, and gift description;
search the dataset according to the at least one search parameter; and
display on a screen, a sub-set of contacts of the contact list mapped to dataset entries matching the at least one search parameter.

16. The system of claim 13, wherein the gift management module is further configured to receive the gift information from a scanner in communication with the computing device, the scanner configured to scan a code encoding the gift information on the gift.

17. The system of claim 16, wherein the system further includes a code generator module for installation on an external computer, the code generator module configured to receive the gift information from a giver of the gift using an interface in communication with the external computer, and generate a message with instructions for printing the code encoding the gift information.

18. The system of claim 16, wherein the code is a Quick Response (QR) code.

19. The system of claim 17, wherein the code is printed on a sticker for attachment to the gift.

20. The system of claim 13, wherein the gift management module is further configured to:
access a social network stored on a remote central server;
share at least one contact entry including at least one dataset entry with another linked user of the social network; and
search the shared data of linked users of the social network according to at least one search parameter.
